(19) United States
(12) Patent Application Publication
(10) Pub. No.: US 2026/0073274 A1
(43) Pub. Date: Mar. 12, 2026

(54) METHOD FOR TRANSMITTING QUANTUM STATE, METHOD FOR VERIFYING QUANTUM STATE, AND SYSTEM THEREFOR

(71) Applicant: KOREA INSTITUTE OF SCIENCE & TECHNOLOGY INFORMATION, Daejeon (KR)

(72) Inventors: Il Kwon SOHN, Daejeon (KR); Bo Seon KIM, Seoul (KR); Kwang Il BAE, Daejeon (KR); Woo Yeong SONG, Incheon (KR); Chan Kyun LEE, Daejeon (KR); Won Hyuk LEE, Sejong-si (KR)

(73) Assignee: KOREA INSTITUTE OF SCIENCE & TECHNOLOGY INFORMATION, Daejeon (KR)

(21) Appl. No.: 19/259,447

(22) Filed: Jul. 3, 2025

(30) Foreign Application Priority Data
Sep. 6, 2024 (KR) 10-2024-0121632

(51) Int. Cl. G06N 10/70

(52) U.S. Cl. CPC G06N 10/70

(57) ABSTRACT

There is provided a method for transmitting a quantum state, performed by a computing device. The method may comprise generating a second quantum state using a first quantum state and a dummy state, encoding the second quantum state, generating a third quantum state by injecting an uncorrectable error into the encoded second quantum state and transmitting the third quantum state to a receiving node.

### CROSS-REFERENCE TO RELATED APPLICATION

This application claims priority from Korean Patent Application No. 10-2024-0121632 filed on Sep. 6, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for transmitting a quantum state, and more particularly, to methods for transmitting a quantum state and verifying tampering of a quantum state so that such tampering can be easily verified in quantum communication.

### 2. Description of the Related Art

A quantum network refers to communication that connects quantum devices located at distant locations, such as quantum computers, using both quantum and classical links. To ensure proper communication over such long distances, security is a key requirement. To achieve security, it is essential to efficiently and securely transmit arbitrary quantum states over long distances.

Quantum teleportation is a quantum protocol for transmitting arbitrary quantum states using entangled quantum states and quantum and classical links. Quantum teleportation requires a pair of entangled states pre-shared between a transmitting node and a receiving node. When the distance between the transmitting and receiving nodes is long, entanglement swapping is necessary to extend the transmission range.

In linear optical settings, entanglement swapping has a 50% success probability for physical Bell State Measurement (BSM). Accordingly, as the distance and the number of nodes increase, the success probability decreases exponentially.

To alleviate this, logical Bell State Measurement using Quantum Error Correction Codes (QECCs) can be performed, and the success probability can be improved based on code length n_{bsm}. However, this method increases overhead. In particular, when purification is considered, the overhead may further increase. Furthermore, when the distance between the transmitting and receiving nodes is substantial and multiple stages of entanglement swapping and purification are required, the overhead may increase exponentially in proportion to the number of relay nodes.

Therefore, there is a demand for a technology that can suppress overhead increase and enhance the security of quantum channels.

### SUMMARY

One objective of the present disclosure is to provide a method for transmitting a quantum state with reduced overhead and a system therefor.

Another objective of the present disclosure is to provide a method for accurately verifying tampering of a quantum state and a system therefor.

Yet another objective of the present disclosure is to provide a method for reliably transmitting data over a substantially long distance via a plurality of relay nodes and a system therefor.

The objectives of the present disclosure are not limited to those mentioned above, and other objectives not explicitly stated will be clearly understood by those skilled in the art based on the following description.

According to an aspect of the present disclosure, there is provided a method for transmitting a quantum state, performed by a computing device, may comprise generating a second quantum state using a first quantum state and a dummy state, encoding the second quantum state, generating a third quantum state by injecting an uncorrectable error into the encoded second quantum state and transmitting the third quantum state to a receiving node.

In some embodiments, the generating of the second quantum state may comprise obtaining a dummy state associated with mutually unbiased bases and generating the second quantum state by randomly mixing the obtained dummy state into the first quantum state.

In some embodiments, the generating of the third quantum state may comprise encoding the second quantum state based on one or more Quantum Error Correction Code (QECC)-related parameters, obtaining the uncorrectable error; and injecting the obtained uncorrectable error into the encoded second quantum state based on the QECC-related parameters.

In some embodiments, the uncorrectable error may include a Pauli error operator.

In some embodiments, the method may further comprise obtaining a syndrome of the uncorrectable error and transmitting the syndrome to the receiving node.

In some embodiments, the computing device may transmit the syndrome to the receiving node via a classical channel and transmits the third quantum state to the receiving node via a quantum channel.

In some embodiments, may further comprise after the transmitting of the third quantum state to the receiving node, transmitting the uncorrectable error to the receiving node in response to receiving, from the receiving node, a first acknowledgment message related to a successful reception of the third quantum state.

In some embodiments, the computing device may transmit the uncorrectable error to the receiving node via a classical channel.

In some embodiments, the method may further comprise after the transmitting of the uncorrectable error to the receiving node, transmitting a permutation operator and an encoding operator for encoding zero auxiliary states into mutually unbiased states to the receiving node in response to receiving, from the receiving node, a second acknowledgment message related to a successful verification of the third quantum state.

In some embodiments, the permutation operator and the encoding operator may be transmitted to the receiving node via a classical channel.

According to an aspect of the present disclosure, there is provided a method for verifying a quantum state, performed by a computing device, may comprise receiving a quantum state from a transmitting node, receiving an uncorrectable error from the transmitting node, obtaining a first syndrome by applying the uncorrectable error to the quantum state and performing a first verification process on the quantum state by determining whether the obtained first syndrome matches a predetermined second syndrome.

In some embodiments, the predetermined second syndrome may be an all-zero syndrome including zero bits and the performing of the first verification process on the quantum state may comprise determining that the first verification has succeeded when the obtained first syndrome is the all-zero syndrome.

In some embodiments, the method may further comprise before the receiving of the uncorrectable error, receiving a syndrome from the transmitting node and verifying the quantum channel based on whether a syndrome extracted from the quantum state matches the received syndrome.

In some embodiments, the receiving of the uncorrectable error may comprise in response to a successful verification of the quantum channel, transmitting, to the transmitting node, a first acknowledgment message indicating that the quantum state has been successfully received and receiving the uncorrectable error from the transmitting node in response to the transmission of the first acknowledgment message.

In some embodiments, the computing device may receive the syndrome via a classical channel and receives the quantum state via a quantum channel.

In some embodiments, the uncorrectable error may include a Pauli error operator.

In some embodiments, the method may further comprise in response to a successful first verification process, receiving, from the transmitting node, a permutation operator and an encoding operator for encoding zero auxiliary states into mutually unbiased states and performing a second verification process on a dummy state included in the quantum state based on the permutation operator and the encoding operator.

In some embodiments, the computing device may receive the permutation operator and the encoding operator via a classical channel.

In some embodiments, the quantum state may be transmitted from the transmitting node to the computing device via one or more relay nodes.

According to an aspect of the present disclosure, there is provided a computing system comprise at least one processor and a memory storing a computer program executed by the at least one processor. The computer program may include instructions to perform operations of generating a second quantum state using a first quantum state and a dummy state, encoding the second quantum state, generating a third quantum state by injecting an uncorrectable error into the encoded second quantum state and transmitting the third quantum state to a receiving node.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating a quantum communication system according to an embodiment of the present disclosure;

FIG. 2 is a signal processing diagram for explaining how a quantum state is transmitted and verified in a quantum communication system according to an embodiment of the present disclosure;

FIG. 3 is a flowchart for explaining a method in which a transmitting node generates state information and transmits it to a receiving node according to an embodiment of the present disclosure;

FIG. 4 is a flowchart for explaining a method in which a transmitting node transmits data for verification to a receiving node according to an embodiment of the present disclosure;

FIG. 5 is a flowchart for explaining a method for verifying a quantum state at a receiving node according to an embodiment of the present disclosure;

FIG. 6 is a diagram illustrating a quantum communication system for long-distance transmission according to an embodiment of the present disclosure; and

FIG. 7 is a diagram illustrating an exemplary hardware configuration in which a computing system can be implemented in various embodiments.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Embodiments of the present disclosure will hereinafter be described in detail with reference to the accompanying drawings.

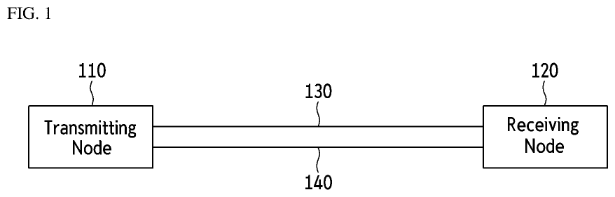

FIG. 1 is a diagram illustrating a quantum communication system according to an embodiment of the present disclosure.

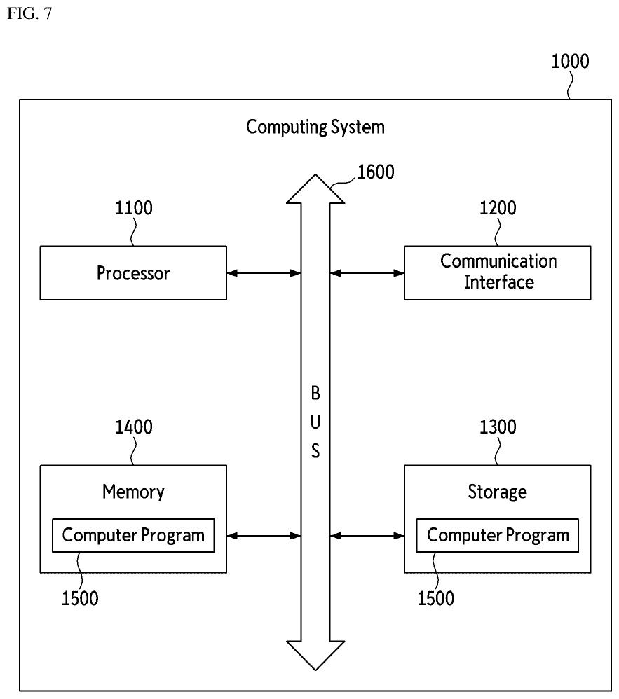

Referring to FIG. 1, the quantum communication system may include a transmitting node 110 and a receiving node 120. Here, each of the transmitting and receiving nodes 110 and 120 may be a computing device that includes at least one processor and memory. For example, each of the transmitting and receiving nodes 110 and 120 may be a computing device that includes components like those depicted in FIG. 7.

A plurality of communication channels may be formed between the transmitting and receiving nodes 110 and 120. In one embodiment, a classical channel 130 and a quantum channel 140 may be created between the transmitting and receiving nodes 110 and 120. The classical channel 130 is a verified communication channel, and data transmitted through the classical channel 130 may be considered reliable. The quantum channel 140 is a channel in which significant loss and noise occur, and data transmitted through the quantum channel 140 may be considered less reliable compared to the classical channel 130.

The transmitting node 110 may transmit a quantum state into which an uncorrectable error Eᵤₙ has been injected to the receiving node 120. In one embodiment, the transmitting node 110 may generate a second quantum state using a first quantum state and a dummy state, encode the generated second quantum state, and inject the uncorrectable error Eᵤₙ into the encoded second quantum state to generate a third quantum state. Thereafter, the transmitting node 110 may transmit the generated third quantum state to the receiving node 120. Additionally, the transmitting node 110 may transmit data necessary for quantum state verification to the receiving node 120.

The receiving node 120 may perform a verification process on the quantum state received from the transmitting node 110. Here, the verification of a quantum state may include at least one of verifying whether the quantum state has been tampered with due to an external attack and verifying whether the quantum channel 140 is in good condition. In one embodiment, the receiving node 120 may receive a quantum state and the uncorrectable error Eᵤₙ from the transmitting node 110, and obtain a syndrome by applying the uncorrectable error Eᵤₙ to the received quantum state. In addition, the receiving node 120 may determine whether the obtained syndrome matches a predetermined syndrome, and perform a verification process on the received quantum state.

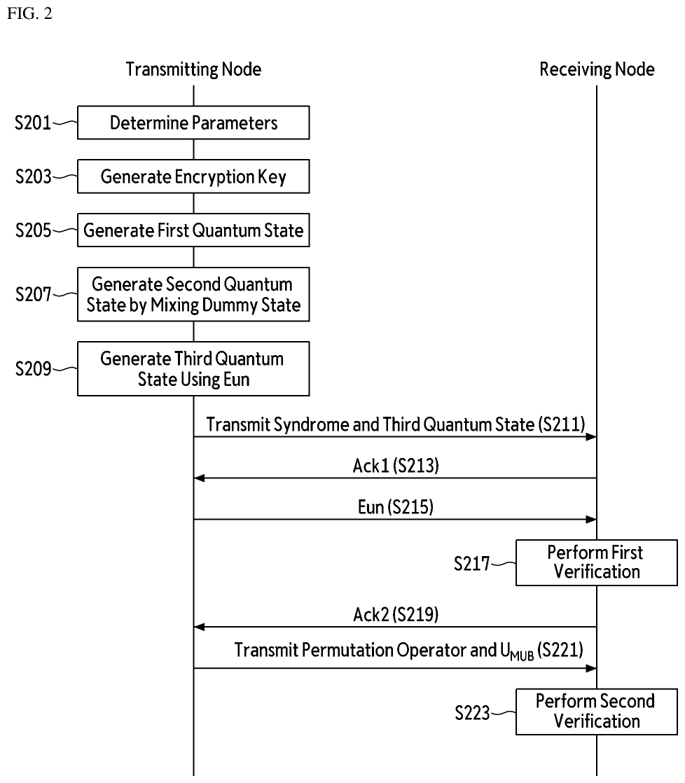

A method will hereinafter be described in which the transmitting node 110 transmits a quantum state to the receiving node 120 and the receiving node 120 verifies the quantum state, with reference to FIG. 2.

FIG. 2 is a signal processing diagram for explaining a method in which a quantum state is transmitted and verified in a quantum communication system according to an embodiment of the present disclosure.

Referring to FIG. 2, the transmitting node 110 may measure a bit error rate of the quantum channel 140 and determine various parameters to be applied to Quantum Error Correction Code (QECC) based on the measured bit error rate (S201). For example, the transmitting node 110 may determine a maximum number of correctable errors t by QECC, a total number n of qubits used for error correction, a number k of logical qubits that actually carry information, and a code distance d that can detect and correct error codes.

Thereafter, the transmitting node 110 may generate a plurality of encryption keys (S203). For example, the transmitting node 110 may generate a plurality of encryption keys with a predetermined number of bits. The transmitting node 110 may generate four encryption keys, for example, first, second, third, and fourth encryption keys. Some of the four encryption keys may have the same number of bits, and all the four encryption keys may have different numbers of bits. In one embodiment, each of the first through third encryption keys may have the same length (e.g., a length of k-k′ bits) as a dummy state to be described later, and the fourth encryption key may be longer than the first through third encryption keys. These four encryption keys may be used in generating at least one of first through third quantum states to be described below.

Thereafter, the transmitting node 110 may generate a first quantum state (S205). In one embodiment, the transmitting node 110 may generate arbitrary k′-qubit information as a first quantum state |ψ′ [symbol] . The arbitrary k′-qubit information, i.e., the first quantum state |ψ′ [symbol] , may be expressed as Equation 1 below.

$$\vert {ψ}^{′} 〉 = {\sum }_{i}^{{2}^{{k}^{′}}} {c}_{i} \vert {m}_{i} 〉 \qquad [ Equation 1 ]$$

Here, mᵢ denotes a computational basis state, and cᵢ denotes a complex amplitude associated with the computational basis state mᵢ.

Thereafter, to prevent an external attack, the transmitting node 110 may obtain a dummy state related to mutually unbiased bases (MUBs) and generate a second quantum state by randomly interspersing the obtained dummy state with the first quantum state (S207). In one embodiment, the dummy state may be pre-generated and stored in the transmitting node 110. In some embodiments, when a quantum state to be transmitted is generated, the transmitting node 110 may randomly generate a dummy state of a predetermined length.

In one embodiment, the transmitting node 110 may randomly mix a first group of bits forming the dummy state and a second group of bits forming the first quantum state, thereby interspersing the dummy state randomly into the first quantum state to generate the second quantum state. For example, the transmitting node 110 may randomly intersperse a dummy state |D [symbol] , which has a length of k-k′ and is associated with two state sets {|0 [symbol] , |1 [symbol] } and {|+ [symbol] , |− [symbol] } into the first quantum state |ψ′ [symbol] based on MUBs arranged at random positions.

The dummy state |D [symbol] may be expressed by Equation 2 below.

$${\vert D 〉 = {{⊗}^{k - {k}^{′}}}_{i = 1} {X}^{{κ}_{i}^{1}} {Z}^{{κ}_{i}^{2}} {H}^{{κ}_{i}^{3}} \vert 0 〉 = {U}_{MUB} \vert 0 〉}^{⊗ k - {k}^{′}} \qquad [ Equation 2 ]$$

Here, X and Z are Pauli operators, H is a Hadamard operator, [symbol] are operators that are applied when their corresponding bits are 1, but act as identity operators when their corresponding bits are 0, and U_{MUB} is an encoding operator for encoding zero auxiliary states into mutually unbiased states.

Thereafter, the transmitting node 110 may encode the second quantum state using QECC and generate the third quantum state by injecting the uncorrectable error Eᵤₙ into the encoded second quantum state (S209). Here, the uncorrectable error Eᵤₙ may be a bit or a bit string that is not corrected even when using QECC. Injecting the uncorrectable error Eu into the second quantum state may involve performing an operation between one or more bits of the uncorrectable error Eᵤₙ and multiple bits of the second quantum state through a specific operator. In this case, the third quantum state may be generated as a result of the operation.

The transmitting node 110 may encode the second quantum state using various parameters applied to QECC. For example, the transmitting node 110 may encode the second quantum state based on the total number n of qubits used for error correction, the number k of logical qubits that actually carry information, and the code distance d for detecting and correcting error codes.

An n-qubit state |ψ [symbol] for QECC encoding based on [[n, k, d]] may be expressed as Equation 3 below.

$$\begin{matrix}{{\vert ψ 〉 = ( {P}_{{κ}^{4}} ⊗ {I}^{⊗ n - k} ) \vert {ψ}^{′} 〉 {U}_{MUB} \vert 0 〉}^{⊗ k - {k}^{′}} \vert 0 〉}^{⊗ n - k} \\ {= ( {P}_{{κ}^{4}} ⊗ {I}^{⊗ n - k} ) ( {I}^{⊗ {k}^{′}} ⊗ {U}_{UMB} ⊗ {I}^{⊗ n - k} ) \vert {ψ}^{′} 〉 \vert 0 〉}^{⊗ n - {k}^{′}} \\ {= {U}_{c} \vert {ψ}^{′} 〉 \vert 0 〉}^{⊗ n - {k}^{′}}\end{matrix} \qquad [ Equation 3 ]$$

Here, Pₖ_{⁴} is an operator that permutes the qubits of the dummy state |D [symbol] .

The transmitting node 110 may encode the n-qubit state |ψ [symbol] into a logical state using a QECC encoding operator UE. The encoded logical state, i.e., |ψ [symbol] _{L}, may be expressed as Equation 4 below. The encoded logical state |ψ [symbol] _{L} in Equation 4 may be the encoded second quantum state.

$${\vert ψ 〉}_{L} = {U}_{E} \vert ψ 〉 \qquad [ Equation 4 ]$$

Thereafter, the transmitting node 110 may inject the uncorrectable error Eᵤₙ, which cannot be corrected even by QECC, into the encoded second quantum state, i.e., |ψ [symbol] _{L}. For example, the uncorrectable error Eᵤₙ may include a randomly selected Pauli error operator. In this case, an operation may be performed based on the Pauli error operator and the encoded second quantum state |ψ [symbol] _{L}, and as a result of the operation, the third quantum state may be generated. The uncorrectable error Eᵤₙ may serve to enhance security against an external attack such as an intercept attack or random attack.

When the third quantum state is generated by injecting the uncorrectable error Eᵤₙ into the encoded second quantum state |ψ [symbol] _{L}, the third quantum state may be understood as being encrypted based on the uncorrectable error Eᵤₙ.

The encoded and encrypted (i.e., Eᵤₙ-injected) third quantum state, i.e., |ψ [symbol] _{E}, may be expressed as Equation 5 below.

$${{\vert ψ 〉}_{E} = {E}_{un} \vert ψ 〉}_{L} \qquad [ Equation 5 ]$$

Thereafter, the transmitting node 110 may calculate a syndrome s of the uncorrectable error Eᵤₙ, and transmit the third quantum state |ψ [symbol] _{E} and the syndrome s to the receiving node 120 (S211). In one embodiment, the transmitting node 110 may transmit the third quantum state |ψ [symbol] _{E} via the quantum channel 140 and transmit the syndrome s via the classical channel 130.

Thereafter, in response to receipt of the third quantum state |ψ [symbol] _{E}, the receiving node 120 may extract a syndrome from the third quantum state |ψ [symbol] _{E} and determine whether the extracted syndrome matches the syndrome s received from the transmitting node 110. If the extracted syndrome is determined to match the received syndrome s, the receiving node 120 may determine that the channel used is normal. Here, the channel determined to be normal may be the quantum channel 140.

If the channel is determined to be normal, the receiving node 120 may transmit a first acknowledgment message Ack1 to the transmitting node 110 to indicate that third quantum state |ψ [symbol] _{E} has been received normally (S213).

Conversely, if the extracted syndrome is determined as not being a match for the received syndrome s, the receiving node 120 may determine that the channel used is abnormal. Here, the channel determined to be abnormal may be an unstable quantum channel 140 due to excessive noise.

If the channel is determined to be abnormal, the receiving node 120 may perform an error correction process on the third quantum state |ψ [symbol] _{E} based on a syndrome s received via the classical channel 130. If the error correction process has succeeded or the channel is determined to be normal, the receiving node 120 may transmit the first acknowledgment message Ack1 to the transmitting node 110.

Thereafter, in response to receipt of the first acknowledgment message Ack1, the transmitting node 110 may transmit the uncorrectable error Eᵤₙ to the receiving node 120 (S215). In one embodiment, the transmitting node 110 may transmit the uncorrectable error Eᵤₙ via the classical channel 130.

Thereafter, the receiving node 120 may perform a first verification process on the third quantum state |ψ [symbol] _{E} by applying the uncorrectable error Eᵤₙ to the third quantum state |ψ [symbol] _{E} and performing first syndrome extraction with the uncorrectable error Eᵤₙ applied (S217). In one embodiment, the receiving node 120 may determine whether a first syndrome extracted from the third quantum state |ψ [symbol] _{E} with the uncorrectable error Eᵤₙ applied has predetermined values and perform the first verification process on the third quantum state |ψ [symbol] _{E}. For example, the receiving node 120 may perform the first verification process by determining whether the first syndrome matches a second syndrome composed of the predetermined values. If both the third quantum state |ψ [symbol] _{E} and the uncorrectable error Eᵤₙ are not tampered with, the first syndrome may match the second syndrome composed of the predetermined values.

For example, if the first syndrome matches the second syndrome, which is composed of all zeros, the receiving node 120 may determine that the first verification process is successful. On the other hand, if the first syndrome does not match the second syndrome, the receiving node 120 may determine that the first verification process for the third quantum state |ψ [symbol] _{E} has failed and terminate subsequent processes. That is, if the first syndrome is not all zeros, the receiving node 120 may determine that at least one of the third quantum state |ψ [symbol] _{E} and the uncorrectable error Eᵤₙ has been tampered with due to an external attack, and terminate the subsequent processes.

If at least one of the third quantum state |ψ [symbol] _{E} and the uncorrectable error Eᵤₙ is determined to have been tampered with, the receiving node 120 may transmit a warning message to the transmitting node 110 to report an external attack. In this case, the receiving node 120 may transmit the warning message to the transmitting node 110 using either or both of the quantum channel 140 and the classical channel 130.

In contrast, if it is determined that the first verification process is successful, the receiving node 120 may transmit a second acknowledgment message Ack2, indicating success of the first verification process, to the transmitting node 110 (S219).

In response to receipt of the second acknowledgment message Ack2, the transmitting node may transmit a permutation operator Pₖ_{⁴} and an encoding operator U_{MUB} to the receiving node 120 (S221). Here, the permutation operator Pₖ_{⁴} may be an operator that permutes the qubits of the dummy state |D [symbol] , used when encoding the second quantum state |ψ [symbol] _{L}. In addition, the encoding operator U_{MUB} may be an operator used when injecting the dummy state |D) into the first quantum state |ψ′ [symbol] , i.e., an operator that encodes zero auxiliary states into mutually unbiased states. In one embodiment, the transmitting node 110 may transmit the permutation operator Pₖ_{⁴} and the encoding operator U_{MUB} to the receiving node 120 via the classical channel 130.

The receiving node 120 may perform a second verification process on the third quantum state |ψ [symbol] _{E} by determining whether the dummy state |D [symbol] included in the third quantum state |ψ [symbol] _{E} has been tampered with, using the received permutation operator Pₖ_{⁴} and encoding operator U_{MUB} (S223). For example, the receiving node 120 may generate encoded data by encoding the dummy state |D [symbol] using the encoding operator U_{MUB}, and may generate measurement result data from the dummy state |D [symbol] included in the third quantum state |ψ [symbol] _{E}. Here, the measurement result data reflects the characteristics of the dummy state |D [symbol] . The receiving node 120 may identify the dummy state |D [symbol] in the third quantum state |ψ [symbol] _{E} using the permutation operator Pₖ_{⁴}, and determine the characteristics of the identified dummy state |D [symbol] using the encoding operator U_{MUB}, thereby generating measurement result data reflecting the characteristics of the dummy state |D [symbol] .

The receiving node 120 may perform the second verification process on the third quantum state |ψ [symbol] _{E} based on consistency between the encoded data and the measurement result data. For example, if the characteristics of the dummy state |D [symbol] , included in the measurement result data, completely match the characteristics of the dummy state |D [symbol] , extracted from the encoded data, it may be determined that the second verification process is successful. Here, the characteristics may be bias-related characteristics.

If the second verification process is determined to have failed, the receiving node 120 may determine that the third quantum state |ψ [symbol] _{E} has been tampered with through an external attack such as intermediate interception, terminate the subsequent processes, and transmit a warning message to the transmitting node 110.

Conversely, if the second verification process is determined to be successful, the receiving node 120 may determine that the third quantum state |ψ [symbol] _{E} is normal and proceed with the subsequent processes.

According to this embodiment, it is possible to accurately determine whether an external attack such as intermediate interception or eavesdropping has occurred during quantum communication, thereby enhancing the security of the quantum communication. In addition, by generating a second quantum state including a dummy state for verification, injecting an uncorrectable error into the encoded second quantum state to generate a third quantum state, and performing quantum communication using the third quantum state, it is possible to minimize overhead and enhance security in performing quantum communication.

Furthermore, according to this embodiment, since a quantum channel is verified based on a syndrome, it is possible to prevent a quantum state from being altered through an unstable quantum channel.

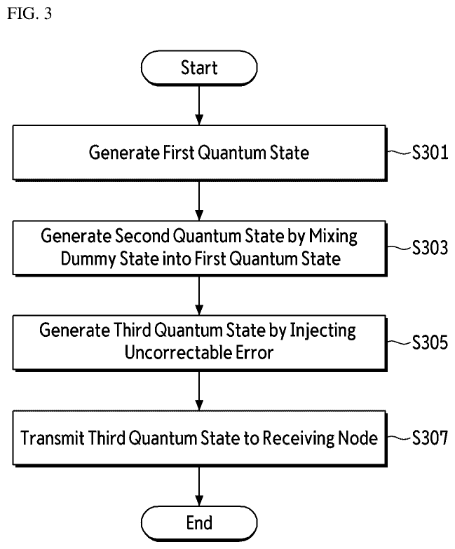

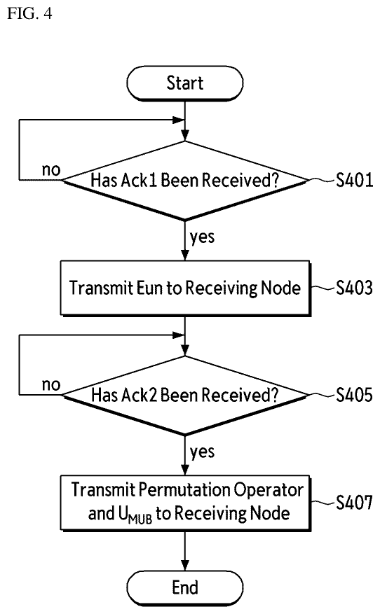

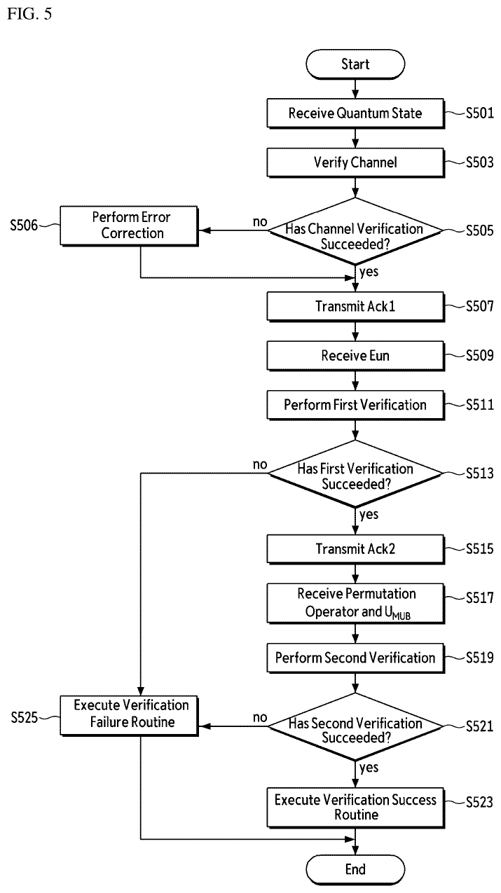

A method in which the transmitting node 110 transmits state information and data to the receiving node 120 will hereinafter be described with reference to FIGS. 3 and 4, and a method in which the receiving node 120 verifies the state information will hereinafter be described with reference to FIG. 5.

Methods according to embodiments to be described below are merely exemplary for achieving the objectives of the present disclosure, and some steps may be added or omitted as needed. In addition, the methods illustrated in FIGS. 3 through 5 may be performed by at least one processor included in a computing device. For convenience of explanation, the methods illustrated in FIGS. 3 and 4 will hereinafter be described as being performed by the transmitting node 110 of FIG. 1, and the method illustrated in FIG. 5 as being performed by the receiving node 120 of FIG. 1.

FIG. 3 is a flowchart for explaining a method in which the transmitting node 110 generates state information and transmits it to the receiving node 120, according to an embodiment of the present disclosure.

Referring to FIG. 3, the transmitting node 110 may determine one or more parameters based on the error rate of the quantum channel 140, and generate a first quantum state using the determined parameters (S301). In one embodiment, the transmitting node 110 may generate arbitrary k′-qubit information as a first quantum state |ψ′ [symbol] . The arbitrary k′-qubit information, i.e., the first quantum state |ψ′ [symbol] , may be expressed by Equation 1 above.

Thereafter, to enhance security, the transmitting node 110 may randomly mix a dummy state |D [symbol] into the first quantum state |ψ′ [symbol] , thereby generating a second quantum state (S303). In one embodiment, the transmitting node 110 may obtain a dummy state associated with MUBs and randomly mix the obtained dummy state into the first quantum state |ψ′ [symbol] , thereby generating the second quantum state. In another embodiment, the transmitting node 110 may mix a first group of bits of the dummy state |D [symbol] and a second group of bits of the first quantum state |ψ′ [symbol] to randomly mix the dummy state |D [symbol] into the first quantum state, and may thereby generate the second quantum state. For example, the transmitting node 110 may randomly mix a dummy state |D [symbol] of a length of k-k′, associated with the two state sets {|0 [symbol] , |1 [symbol] } and {|+ [symbol] , |− [symbol] }, into the first quantum state |ψ′ [symbol] based on randomly positioned MUBs. The dummy state |D [symbol] may be expressed by Equation 2 above.

Thereafter, the transmitting node 110 may encode the second quantum state and inject an uncorrectable error Eᵤₙ into the encoded second quantum state, thereby generating a third quantum state (S305). In one embodiment, the transmitting node 110 may encode the second quantum state based on one or more QECC-related parameters, obtain an uncorrectable error Eᵤₙ, and inject the obtained uncorrectable error Eᵤₙ into the encoded second quantum state based on the QECC-related parameters. For example, the uncorrectable error Eᵤₙ may include a Pauli error operator.

Thereafter, the transmitting node 110 may transmit the third quantum state to the receiving node 120 (S307). In some embodiments, the transmitting node 110 may calculate the syndrome of the uncorrectable error Eᵤₙ and transmit the calculated syndrome to the receiving node 120. The transmitting node 110 may transmit the calculated syndrome to the receiving node 120 via the classical channel 130 and transmit the third quantum state via the quantum channel 140.

FIG. 4 is a flowchart for explaining a method in which the transmitting node 110 transmits data for verification to the receiving node 120, according to an embodiment of the present disclosure. The method of FIG. 4 may follow the method of FIG. 3.

Referring to FIG. 4, the transmitting node 110 may monitor whether a first acknowledgment message Ack1 is received from the receiving node 120 (S401). Here, the first acknowledgment message Ack1 may indicate that the third quantum state |ψ [symbol] _{E} transmitted by the transmitting node 110 has been successfully received at the receiving node 120.

If the first acknowledgment message Ack1 is received, the transmitting node 110 may transmit the uncorrectable error Eᵤₙ to the receiving node 120 (S403). At this time, the transmitting node 110 may transmit the uncorrectable error Eᵤₙ to the receiving node 120 via the classical channel 130. The receiving node 120 may perform a first verification process on the third quantum state |ψ [symbol] _{E} using the uncorrectable error Eᵤₙ. Here, the first verification process may determine whether the third quantum state |ψ [symbol] _{E} has been tampered with.

The transmitting node 110 may monitor whether a second acknowledgment message Ack2 is received from the receiving node (S405). Here, the second acknowledgment message Ack2 may indicate that the first verification process for the third quantum state |ψ [symbol] _{E} has succeeded.

Then, in response to receipt of the second acknowledgment message Ack2 from the receiving node 120, the transmitting node 110 may transmit, to the receiving node 120, a permutation operator Pₖ_{⁴} and an encoding operator U_{MUB} for encoding zero auxiliary states into mutually unbiased states (S407). In this case, the transmitting node 110 may transmit the permutation operator Pₖ_{⁴} and the encoding operator U_{MUB} to the receiving node 120 via the classical channel 130.

FIG. 5 is a flowchart for explaining a method for verifying a quantum state at a receiving node according to an embodiment of the present disclosure.

Referring to FIG. 5, the receiving node 120 may receive a quantum state from the transmitting node 110 (S501). At this time, the receiving node 120 may receive the quantum state from the transmitting node 110 via the quantum channel 140. Here, the quantum state may be a third quantum state |ψ [symbol] _{E} described above. Additionally, the receiving node 120 may receive a syndrome s from the transmitting node 110. In one embodiment, the receiving node 120 may receive the syndrome s from the transmitting node 110 via the classical channel 130.

Thereafter, the receiving node 120 may extract a syndrome from the quantum state and perform a channel verification process by determining whether the extracted syndrome matches the received syndrome (S503). Here, the channel subject to the channel verification process may refer to the quantum channel 140.

The receiving node 120 may determine whether the channel verification process has succeeded (S505). If the syndrome extracted from the third quantum state is determined not to match the received syndrome s, the receiving node 120 may determine that the channel is abnormal. If the quantum channel 140 is determined to be abnormal, the receiving node 120 may perform an error correction process on the third quantum state |ψ [symbol] _{E} based on the syndrome s received from the transmitting node 110 via the classical channel 130 (S506).

If the error correction process has succeeded or the quantum channel 140 is determined to be normal, the receiving node 120 may transmit a first acknowledgment message Ack1 to the transmitting node 110 (S507).

In response to the transmission of the first acknowledgment message Ack1, the receiving node 120 may receive an uncorrectable error Eᵤₙ from the transmitting node 110 (S509). In one embodiment, the uncorrectable error Eᵤₙ may include a Pauli error operator.

Thereafter, the receiving node 120 may perform a first verification process on the quantum state using the received syndrome s (S511). Specifically, the receiving node 120 may obtain a first syndrome by applying the received uncorrectable error Eᵤₙ to the quantum state, and perform the first verification process by determining whether the obtained first syndrome matches a predetermined second syndrome. In one embodiment, the predetermined second syndrome may be an all-zero syndrome. In this case, if the obtained first syndrome is an all-zero syndrome (i.e., the second syndrome), the receiving node 120 may determine that the first verification process has succeeded.

If the first verification process has succeeded (S513), the receiving node 120 may transmit a second acknowledgment message Ack2 to the transmitting node 110, indicating success of the first verification process (S515).

Thereafter, the receiving node 120 may receive a permutation operator Pₖ_{⁴} and an encoding operator U_{MUB} for encoding zero auxiliary states into mutually unbiased states from the transmitting node 110 (S517).

Thereafter, the receiving node 120 may perform a second verification process on a dummy state included in the quantum state using the permutation operator Pₖ_{⁴} and the encoding operator U_{MUB} (S519). For example, the receiving node 120 may generate encoded data by performing encoding on a dummy state |D [symbol] included in the third quantum state |ψ [symbol] _{E} using the encoding operator U_{MUB}, and generate measurement result data from the dummy state |D [symbol] . Here, the measurement result data reflects the characteristics of the dummy state |D [symbol] . The receiving node 120 may identify the dummy state |D [symbol] in the third quantum state |ψ [symbol] _{E} using the permutation operator Pₖ_{⁴}, and determine the characteristics of the identified dummy state |D [symbol] using the encoding operator U_{MUB}, thereby generating measurement result data reflecting the characteristics of the dummy state |D [symbol] .

The receiving node 120 may perform the second verification process on the third quantum state |ψ [symbol] _{E} based on the consistency between the encoded data and the measurement result data. For example, if the characteristics of the dummy state included in the measurement result data match all characteristics of the dummy state extracted from the encoded data, the second verification process may be determined to be successful.

If both the first and second verification processes have succeeded (S521), the receiving node 120 may proceed with verification success processing and then proceed with a verification success routine (S523). For example, the verification success routine may include transmitting the quantum state to another node, transmitting specific data to another node, or executing a predefined program.

If any of the channel verification, first verification, and second verification processes has failed, the receiving node 120 may proceed with a verification failure routine (S525). For example, the verification failure routine may include transmitting an alarm message to a nearby node indicating an external attack, sending a message indicating that the quantum channel 140 is unstable, stopping data transmission and reception through the quantum channel 140, or executing a predefined security-related program.

Meanwhile, one or more nodes may operate as relay nodes to transmit the quantum state to a distant node.

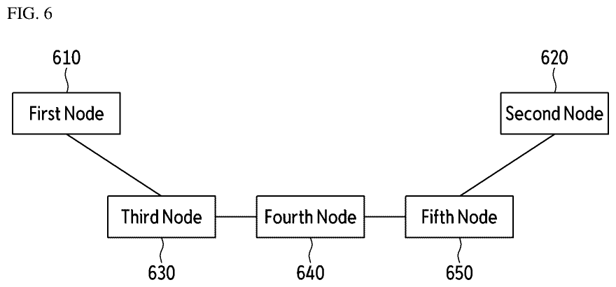

FIG. 6 is a diagram illustrating a quantum communication system for long-distance transmission according to an embodiment of the present disclosure.

Referring to FIG. 6, the quantum communication system may include a plurality of first, second, third, fourth, and fifth nodes 610, 620, 630, 640, and 650. Some of the first, second, third, fourth, and fifth nodes 610, 620, 630, 640, and 650 may operate as relay nodes for relaying quantum states.

At least one of a classical channel and a quantum channel may be created between each pair of nodes among the first, second, third, fourth, and fifth nodes 610, 620, 630, 640, and 650. In some embodiments, only a classical channel may be created between the first and second nodes 610 and 620, and no quantum channel may be created between the first and second nodes 610 and 620. In this case, the third, fourth, and fifth nodes 630, 640, and 650 may operate as relay nodes to transmit a quantum state to the second node 620. The solid lines in FIG. 6 illustrate a quantum channel, and a classical channel may be created among all the first, second, third, fourth, and fifth nodes 610, 620, 630, 640, and 650.

The third, fourth, and fifth nodes 630, 640, and 650 that perform the function of relay nodes may relay a quantum state to a long-distance destination. Additionally, the third, fourth, and fifth nodes 630, 640, and 650 may perform an error correction process on a quantum state.

In FIG. 6, the first node 610 may be a transmitting node that transmits a quantum state, the second node 620 may be a destination node that receives the quantum state, and the third, fourth, and fifth nodes 630, 640, and 650 may operate as relay nodes. The number of relay nodes depicted in FIG. 6 is merely exemplary, and the number of relay nodes may vary.

In this case, the first node 610 may generate a quantum state (i.e., a third quantum state described above with reference to FIG. 2) and transmit the quantum state to the third node 630. In addition, the first node 610 may broadcast a syndrome to all the other nodes, i.e., the second, third, fourth, and fifth nodes 620, 630, 640, and 650, via the classical channel.

The third node 630 may perform a verification process on the quantum channel using the broadcast syndrome and perform an error correction process on the quantum state based on the syndrome.

Then, the third node 630 may transmit the quantum state to the fourth node 640, and the fourth node 640 may perform a verification process on the quantum channel and, if needed, an error correction process on the quantum state based on the syndrome.

The fourth node 640 may transmit the quantum state to the fifth node 650, and the fifth node 650 may perform a verification process on the quantum channel and, if needed, an error correction process on the quantum state before forwarding the quantum state to the second node 620.

If the verification or error correction process for the quantum channel has succeeded, the second node 620, which is a receiving node, may transmit a first acknowledgment message Ack1 to the first node 610 via the classical channel.

In this case, the first node 610 may transmit an uncorrectable error Eᵤₙ to the second node 620 via the classical channel.

Thereafter, the second node 620 may perform a first verification process on the quantum state using the uncorrectable error Eᵤₙ, and if successful, may transmit a second acknowledgment message Ack2 to the first node 610 via the classical channel.

Thereafter, in response to the second acknowledgment message Ack2, the first node 610 may transmit a permutation operator Pₖ_{⁴} and an encoding operator U_{MUB} to the second node 620 via the classical channel.

The second node 620 may perform a second verification process on the dummy state included in the quantum state using the permutation operator Pₖ_{⁴} and the encoding operator U_{MUB}. If both the first and second verification processes have succeeded, the second node 620 may proceed with a predefined follow-up process. On the other hand, if either the first or second verification process has failed, the second node 620 may not proceed with the predefined follow-up process.

As described above, quantum states can be transmitted to distant nodes with reduced overhead. In addition, by performing, at each node, verification on both the node that has transmitted quantum states and the channel used, the quality of quantum communication can be improved.

Hereinafter, a hardware configuration of an exemplary computing system according to some embodiments will be described with reference to FIG. 7. The computing system described with reference to FIG. 7 may refer to the transmitting node and/or receiving node described above.

FIG. 7 is a hardware configuration view of an exemplary computing system 1000 according to some embodiments of the present disclosure.

The computing system 1000 may include at least one processor 1100, a bus 1600, a communication interface 1200, a memory 1400, which loads a computer program 1500 to be executed by the processor 1100, and a storage 1300, which stores the computer program 1500. Only components related to the embodiment are illustrated in FIG. 7. Accordingly, a person skilled in the art to which the embodiments of the present disclosure may recognize that other general components may be included in addition to the components illustrated in FIG. 7.

The processor 1100 may control the overall operation of each of the components of the computing system 1000. The processor 1100 may be configured to include at least one of a central processing unit (CPU), a micro-processor unit (MPU), a micro-controller unit (MCU), a graphics processing unit (GPU), or any form of processor well-known in the field of the present disclosure. Additionally, the processor 1100 may perform computations for at least one application or program to execute operations/methods according to some embodiments of the present disclosure. The computing system 1000 may be equipped with one or more processors.

The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random-access memory (RAM), but the present disclosure is not limited thereto.

The bus 1600 may provide communication functionality between the components of the computing system 1000. The bus 1600 may be implemented in various forms such as an address bus, a data bus, and a control bus. The communication interface 1200 may be connected to a communication network. The storage 1300 may non-transitorily store at least one computer program 1500. The storage 1300 may be configured to include a non-volatile memory such as a flash memory, as well as a computer-readable recording medium in any form well-known in the technical field of the present disclosure, such as a hard disk or a removable disk.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure. The computer program 1500 may include instructions for methods according to various embodiments described with reference to FIGS. 1 to 6.

According to one embodiment, the computer program 1500 may include instructions for operations of generating a second quantum state using a first quantum state and a dummy state, encoding the second quantum state, generating a third quantum state by injecting an uncorrectable error into the encoded second quantum state and transmitting the third quantum state to a receiving node.

Additionally or alternatively, the computer program 1500 may include instructions for operations of receiving a quantum state from a transmitting node, receiving an uncorrectable error from the transmitting node, obtaining a first syndrome by applying the uncorrectable error to the quantum state and performing a first verification process on the quantum state by determining whether the obtained first syndrome matches a predetermined second syndrome.

In some embodiments, the computing system 1000 as described with reference to FIG. 7 may be configured using one or more physical servers included in a server farm based on cloud technology such as virtual machines. In this case, at least some of the components as illustrated in FIG. 7, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 7. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A method for transmitting a quantum state, performed by a computing device, comprising:
generating a second quantum state using a first quantum state and a dummy state;
encoding the second quantum state;
generating a third quantum state by injecting an uncorrectable error into the encoded second quantum state; and
transmitting the third quantum state to a receiving node.

2. The method of claim 1, wherein the generating of the second quantum state comprises: obtaining a dummy state associated with mutually unbiased bases; and generating the second quantum state by randomly mixing the obtained dummy state into the first quantum state.

3. The method of claim 1, wherein the generating of the third quantum state comprises: encoding the second quantum state based on one or more Quantum Error Correction Code (QECC)-related parameters; obtaining the uncorrectable error; and injecting the obtained uncorrectable error into the encoded second quantum state based on the QECC-related parameters.

4. The method of claim 1, wherein the uncorrectable error includes a Pauli error operator.

5. The method of claim 1, further comprising:
obtaining a syndrome of the uncorrectable error; and
transmitting the syndrome to the receiving node.

6. The method of claim 5, wherein the computing device transmits the syndrome to the receiving node via a classical channel and transmits the third quantum state to the receiving node via a quantum channel.

7. The method of claim 1, further comprising:
after the transmitting of the third quantum state to the receiving node, transmitting the uncorrectable error to the receiving node in response to receiving, from the receiving node, a first acknowledgment message related to a successful reception of the third quantum state.

8. The method of claim 7, wherein the computing device transmits the uncorrectable error to the receiving node via a classical channel.

9. The method of claim 7, further comprising:
after the transmitting of the uncorrectable error to the receiving node, transmitting a permutation operator and an encoding operator for encoding zero auxiliary states into mutually unbiased states to the receiving node in response to receiving, from the receiving node, a second acknowledgment message related to a successful verification of the third quantum state.

10. The method of claim 9, wherein the permutation operator and the encoding operator are transmitted to the receiving node via a classical channel.

11. A method for verifying a quantum state, performed by a computing device, comprising:
receiving a quantum state from a transmitting node;
receiving an uncorrectable error from the transmitting node;
obtaining a first syndrome by applying the uncorrectable error to the quantum state; and
performing a first verification process on the quantum state by determining whether the obtained first syndrome matches a predetermined second syndrome.

12. The method of claim 11, wherein
the predetermined second syndrome is an all-zero syndrome including zero bits, and
the performing of the first verification process on the quantum state comprises determining that the first verification has succeeded when the obtained first syndrome is the all-zero syndrome.

13. The method of claim 11, further comprising:
before the receiving of the uncorrectable error, receiving a syndrome from the transmitting node; and
verifying the quantum channel based on whether a syndrome extracted from the quantum state matches the received syndrome.

14. The method of claim 13, wherein the receiving of the uncorrectable error comprises: in response to a successful verification of the quantum channel, transmitting, to the transmitting node, a first acknowledgment message indicating that the quantum state has been successfully received; and receiving the uncorrectable error from the transmitting node in response to the transmission of the first acknowledgment message.

15. The method of claim 13, wherein the computing device receives the syndrome via a classical channel and receives the quantum state via a quantum channel.

16. The method of claim 13, wherein the uncorrectable error includes a Pauli error operator.

17. The method of claim 11, further comprising:
in response to a successful first verification process, receiving, from the transmitting node, a permutation operator and an encoding operator for encoding zero auxiliary states into mutually unbiased states; and
performing a second verification process on a dummy state included in the quantum state based on the permutation operator and the encoding operator.

18. The method of claim 17, wherein the computing device receives the permutation operator and the encoding operator via a classical channel.

19. The method of claim 11, wherein the quantum state is transmitted from the transmitting node to the computing device via one or more relay nodes.

20. A computing system comprising:
at least one processor; and
a memory storing a computer program executed by the at least one processor,
wherein the computer program includes instructions to perform operations of: generating a second quantum state using a first quantum state and a dummy state; encoding the second quantum state; generating a third quantum state by injecting an uncorrectable error into the encoded second quantum state; and transmitting the third quantum state to a receiving node.
